(19) United States
(12) Patent Application Publication
(10) Pub. No.: US 2016/0354910 A1
(43) Pub. Date: Dec. 8, 2016

(54) FOLDING WRENCH ASSEMBLY

(71) Applicant: Cequent Consumer Products, Inc., Solon, OH (US)

(72) Inventors: Theodore Joseph Siegel, Mayfield Heights, OH (US); Eric Michael Yukich, Stow, OH (US)

(21) Appl. No.: 15/175,621

(22) Filed: Jun. 7, 2016

Related U.S. Application Data
(60) Provisional application No. 62/172,555, filed on Jun. 8, 2015.

(51) Int. Cl. B25F 1/04; B25B 13/08; B25B 23/00; B25B 13/04

(52) U.S. Cl. CPC B25F 1/04; B25B 13/04; B25B 13/08; B25B 23/0042

(57) ABSTRACT

Disclosed is a folding tool assembly comprising a top tool having a head and a base with an annular surface, a center tool having a head and a base, and a bottom tool having a head and a base with an annular surface. The bases of the tools may be rotatable along a common axis within a housing relative to one another. An elongated pushbutton with cutouts may selectively align with the annual surfaces of the top and bottom tools wherein the pushbutton body may be spring loaded within the housing. Each of the tools may be placed in a closed locked position and an open locked position relative to the other tools. The top tool and bottom tool may be rotatably attached to a shaft aligned along the common axis.

### CROSS-REFERENCE TO RELATED APPLICATION

This application claims the benefit from U.S. Provisional Patent Application No. 62/172,555, entitled “FOLDING WRENCH ASSEMBLY” filed on Jun. 8, 2015, which is hereby incorporated by reference in its entirety.

### FIELD OF INVENTION

The present invention generally relates to a folding wrench assembly, and more particularly to a multi-tool folding assembly configured for multiple sizes of rotary fasteners.

### BACKGROUND

The present state of wrenches technology is very diverse and there are many different types and styles of wrenches. There exist a type of wrench having a permanently attached wrench shaped heads and a wrench having an interchangeable socket wrench type head. For the purposes of this patent the term “wrench”, “wrenches”, etc. will be used to refer to rotary fastener gripping tools that are permanently fixed to the end of a tool arm. This is in contrast to socket wrenches, which have removable gripping tools (the socket) to allow multiple gripping tools to be interchanged with a single non-ratcheting wrench handle or a ratcheting wrench, handle.

Wrenches normally come in sets of a plurality of sizes with box ends and/or open-end wrench heads. Multiple sized box ends or open wrench heads allow the user to tighten and loosen rotary fasteners (bolts, screws, nuts, specialty fasteners, etc.) of a variety of sizes. When provided as a separate set of wrenches, it becomes easy for a user to lose one. Therefore, it has been known to provide wrench sets that may be combined in a foldable manner to prevent losing a wrench from a wrench set. However, many known foldable wrenches have been unable to provide a mechanism that allows a user to functionally apply torque to a fastener from a selected wrench while positioning the remaining wrenches in a secured torque position. Known devices are clumsy and may be ergonomically inefficient or lack in functionality.

An example of these foldable wrenches includes the “Folding Multi-wrenches” disclosed by PCT application number WO2014/028779. This application discloses various embodiments of a folding multi-wrench device having three wrenches connected along two hinges wherein each wrench may be foldable between an extended position and a storage position. This folding wrench device utilizes a hinge mechanism that may not be configured to allow a plurality of wrenches to be individually foldable between an extended position while remaining in secured alignment. This may make use of the wrench difficult and may make application of torque to the wrench difficult.

As such, embodiments of the disclosed assembly provide a folding tool assembly that may solve the ergonomic and functional deficits of known assemblies.

### SUMMARY

A folding wrench assembly is shown and described. The folding tool assembly comprises a top tool having a top head and a top base with a top base surface, a center tool having a center head and a center base, and a bottom tool having a bottom head and a bottom base with a bottom base surface. The top, center, and bottom bases of the tools may be rotatable along a common axis relative to one another. A lockable hinge having a pushbutton with an elongated body. The elongated body having cutouts. The elongated body may be biased between a locked position and an unlocked position to selectively align with the top and bottom base surfaces of the top and bottom tools. The top, center, and bottom tools may be placed in a closed locked position and an open locked position relative to the other tools. The pushbutton may extend through an aperture within the center base of the center tool. The top tool and bottom tool may be rotatably attached to a shaft aligned along the common axis. The pushbutton body may extend passed the bases of the top, center, and bottom tools. The base of the top tool may include a first notch and second notch that are selectively aligned with the first cutout of the pushbutton body. The base of the bottom tool may include a first notch and a second notch that are selectively aligned with the second cutout of the pushbutton body. The top base, center base, and bottom base of the tools may be positioned within a housing. The elongated body of the pushbutton may be generally parallel with the common axis.

In one embodiment, provided is a folding tool assembly. The folding tool assembly includes a plurality of tools including at least a first tool having a first head and a first base with a first base surface, a second tool having a second head and a second base, and a third tool having a third head and a third base with a third base surface. The first, second, and third bases may be rotatable along a common axis. A lockable hinge may include a housing with a pushbutton. The pushbutton may include an elongated body with cutouts. The pushbutton may be biased between a locked position and an unlocked position to selectively engage the cutouts with the first and third base surfaces. Each of the plurality of tools may be selectively moveable between a closed locked position and an open locked position relative to the other tools. The elongated body of the pushbutton may extend through an aperture within the second base of the second tool. The first tool and third tool may be rotatably attached to a shaft aligned along the common axis. The elongated body of the pushbutton may extend through the housing and may extend passed the first base, the second base, and the third base of the first, second, and third tools, respectively. The first base of the first tool may include a first notch and second notch that are selectively aligned with a first cutout of the elongated body wherein the first tool may be in the open locked position when the second notch is engaged with the elongated body of the pushbutton and may be in the closed locked position when the first notch is engaged with the elongated body of the pushbutton. The third base of the third tool may include a first notch and a second notch that are selectively aligned with the second cutout of the elongated body wherein the third tool may be in the open locked position when the second notch is aligned with the elongated body of the pushbutton and may be in the closed locked position when the first notch is aligned with the elongated body of the pushbutton. The first base, second base, and third base may be positioned within the housing. The elongated body of the pushbutton may be generally parallel to the common axis. The first, second, and third heads of the plurality of tools may have a multi-sized configuration having a fixed grip surface to grip fasteners of a range of sizes. The first head may have a first size, the second head may have a second size and the third head may have a third size wherein the third size is larger than the second size and the second size is larger than the first size. Alternatively, the heads may be a box head wrench style having a closed configuration.

In another embodiment, provided is folding tool assembly including a plurality of tools. The folding tool assembly may comprise a pivotal hinge that allows the tools to be selectively folded in a compact position and an extended position for use. Each tool having an arm spaced between a head and a base wherein each of the bases are rotatable along a common axis. A lockable hinge includes a housing and a pushbutton. The housing may circumscribe the bases of the plurality of tools and the pushbutton may extend within the housing to be biased between locked and unlocked positions wherein the plurality of tools may be pivoted relative to each other in the unlocked position and the plurality of tools may be locked relative to each other in the locked position.

### BRIEF DESCRIPTION OF THE DRAWINGS

Operation of the present teachings may be better understood by reference to the detailed description taken in connection with the following illustrations, wherein:

FIG. 1 is a perspective view of embodiments of a folding tool assembly in a closed position in accordance with the instant disclosure;

FIG. 2 is a first side view the folding tool assembly of FIG. 1;

FIG. 3 is a second side view the folding tool assembly of FIG. 1;

FIG. 4 is a front view of the folding tool assembly of FIG. 1;

FIG. 5 is a top view of the folding tool assembly of FIG. 1;

FIG. 6 is a bottom view the folding tool assembly of FIG. 1;

FIG. 7 is a perspective view of embodiments of the folding tool assembly in an open position in accordance with the instant disclosure;

FIG. 8 is a perspective view of embodiments of the folding tool assembly in an open position in accordance with the instant disclosure;

FIG. 9 is a perspective view of embodiments of the folding tool assembly in an open position in accordance with the instant disclosure;

FIG. 10 is a perspective view of embodiments of a folding tool assembly in a closed position without a housing in accordance with the instant disclosure;

FIG. 11 is a first side view the folding tool assembly of FIG. 10;

FIG. 12 is a second side view the folding tool assembly of FIG. 10;

FIG. 13 is a front view of the folding tool assembly of FIG. 10;

FIG. 14 is a top view of the folding tool assembly of FIG. 10;

FIG. 15 is a bottom view the folding tool assembly of FIG. 10;

FIG. 16 is a perspective view of embodiments of the folding tool assembly in an open position in accordance with the instant disclosure;

FIG. 17 is a perspective view of embodiments of the folding tool assembly in an open position in accordance with the instant disclosure;

FIG. 18 is a perspective view of embodiments of the folding tool assembly in an open position in accordance with the instant disclosure;

FIG. 19 is a side view of embodiments of the folding tool assembly in accordance with the instant disclosure.

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined, switched, or altered without departing from the scope of the present teachings, e.g., features of each embodiment disclosed herein may be combined, switched, or replaced with features of the other embodiments disclosed herein. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

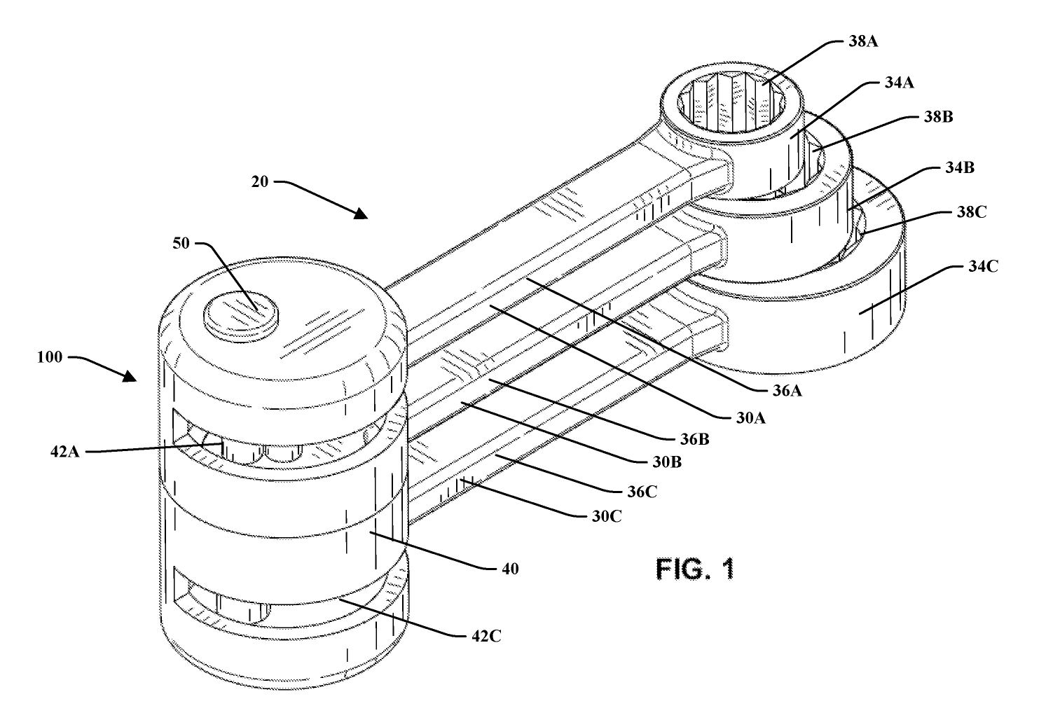

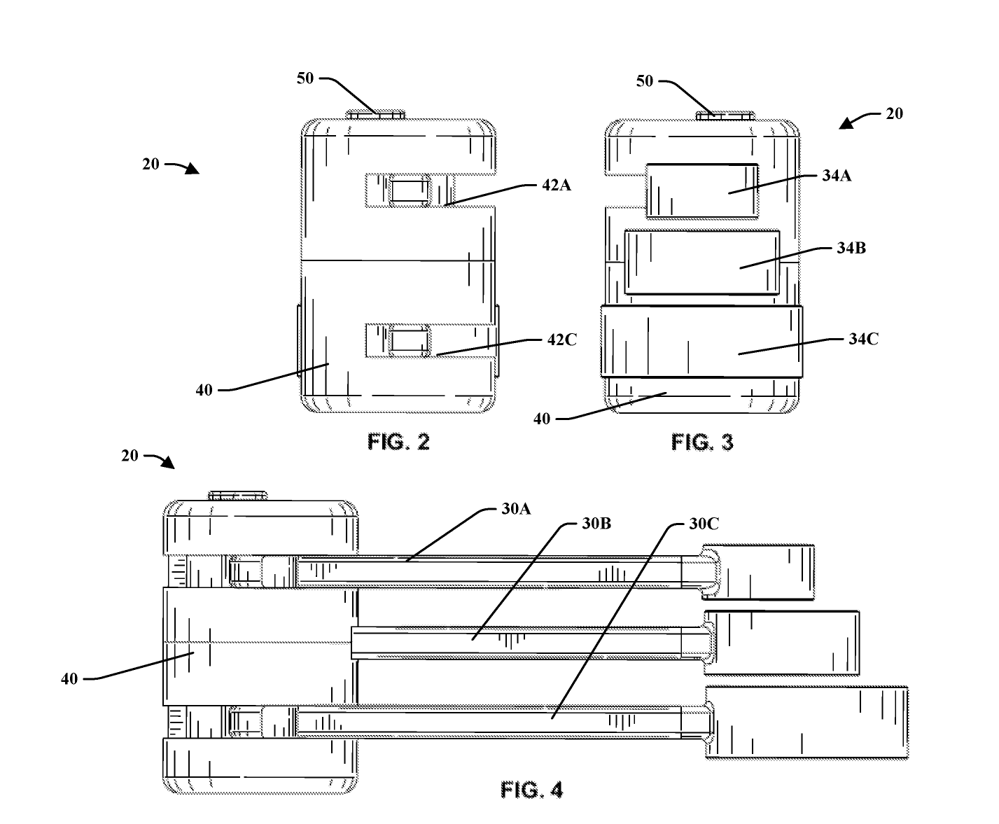

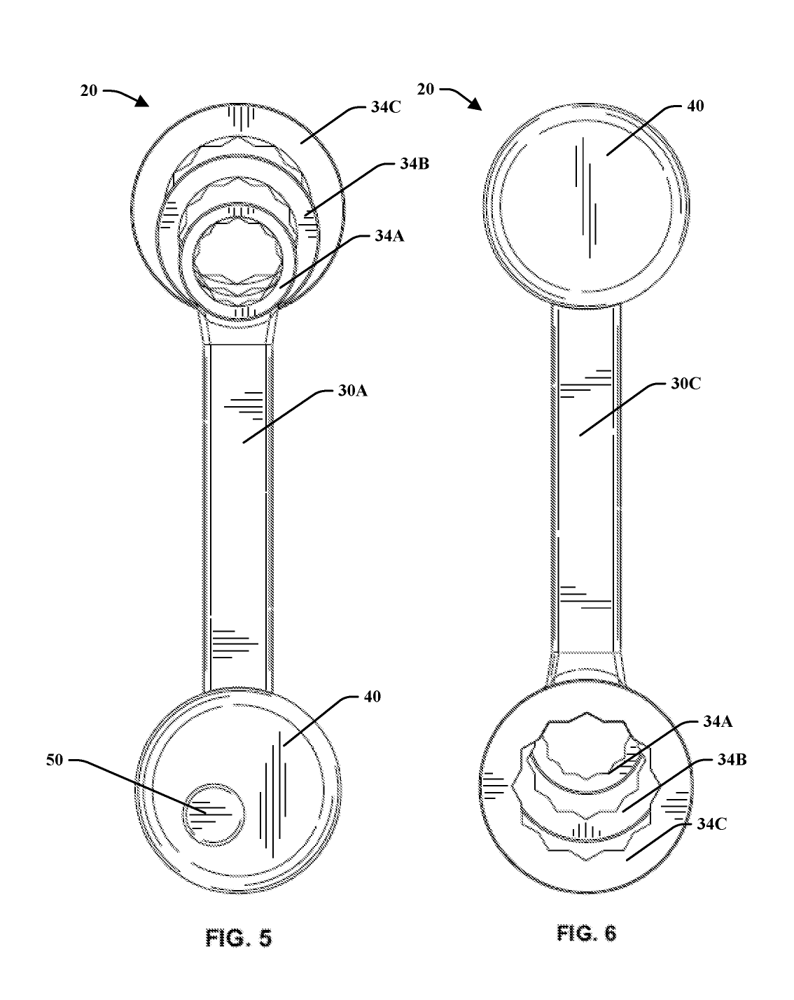

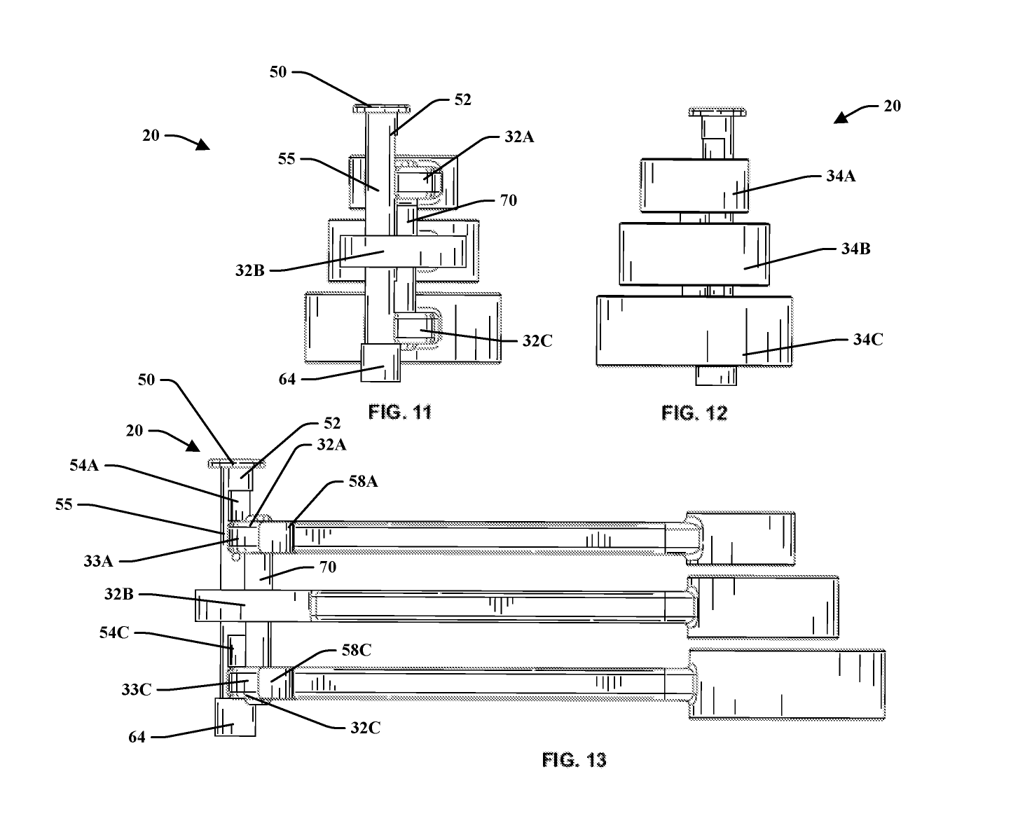

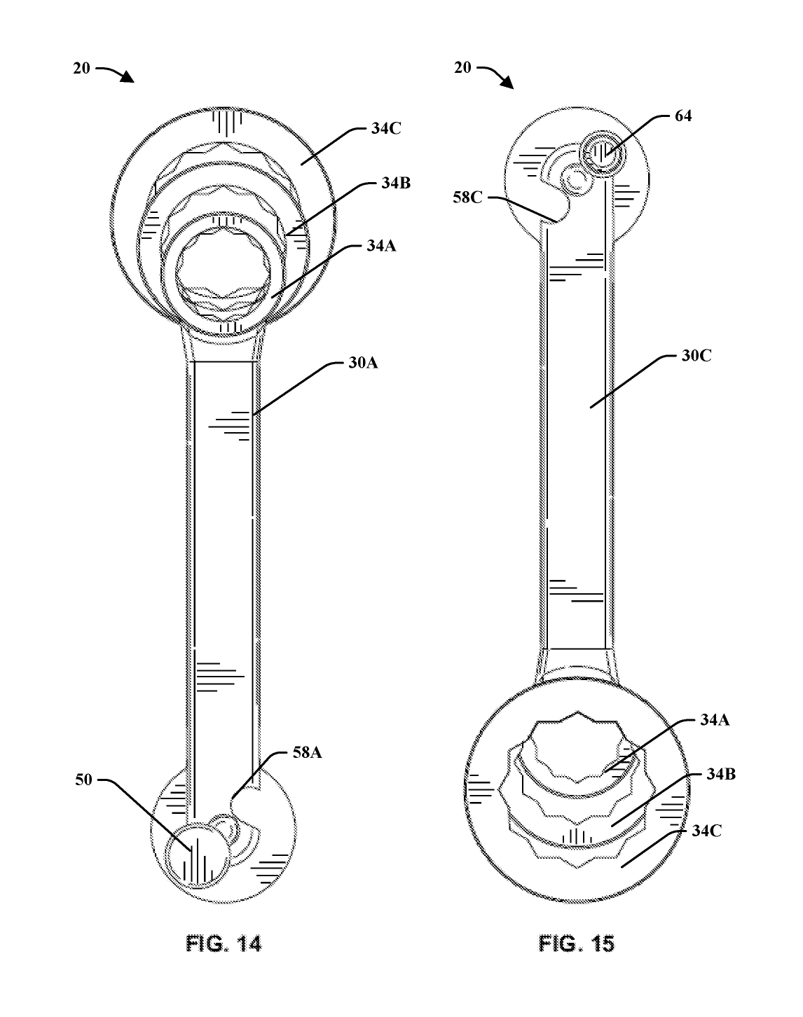

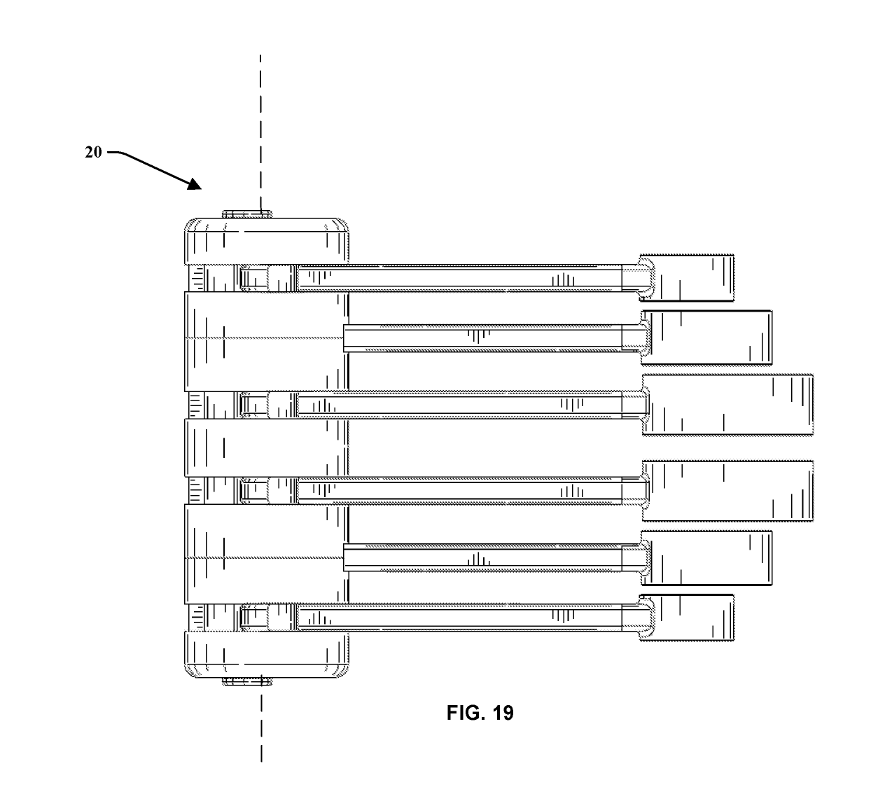

Disclosed is a folding tool assembly 20 having a plurality of tools foldable generally along a common axis and being capable of selectively biasing each tool into an open position and a closed position is shown in FIGS. 1-19. In one embodiment, the folding tool assembly 20 may include a plurality of tools and in particular may include three (3) or more tools. For the sake of brevity, the application will describe three tools. However, these concepts may be scaled to include any number of tools. As illustrated by FIG. 19, the folding tool assembly 20 may be scalable to include more that three tools as it may include 4, 5, 6, 7, 8, 9, or even 10 or more tools.

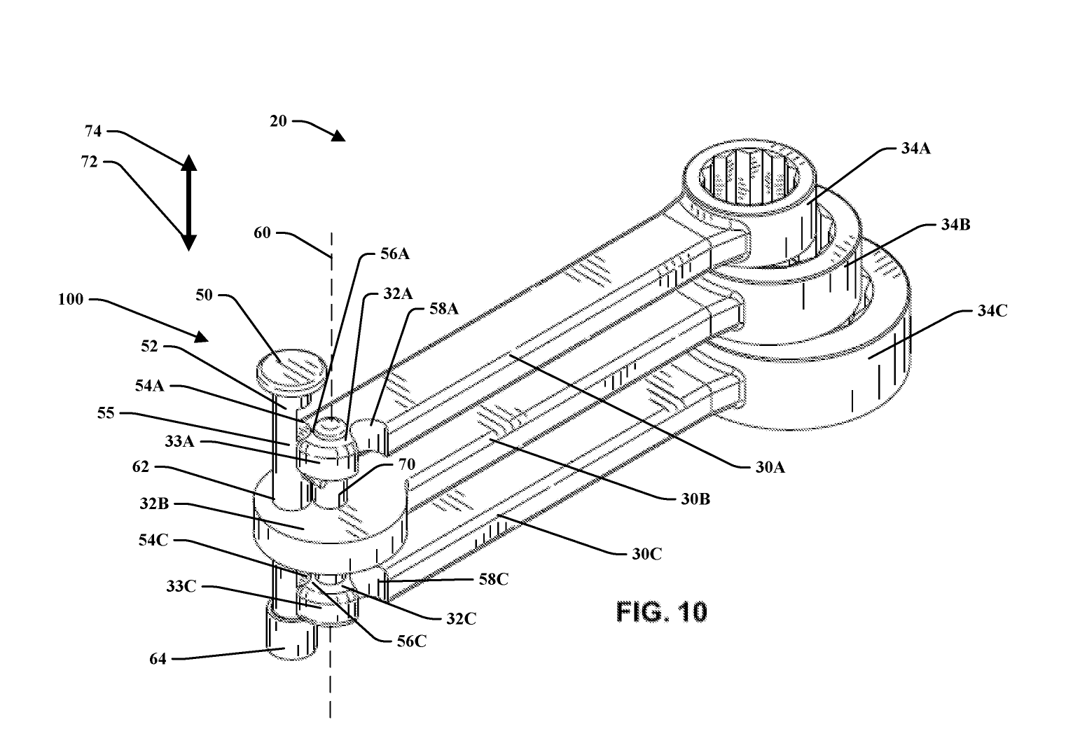

As illustrated by FIGS. 1-18, the folding tool assembly 20 may include three (3) tools, a first top tool 30A, a second center tool 30B, and a third bottom tool 30C. Each tool includes a base 32A, 32B, 32C opposite from a head 34A, 34B, 34C, respectively. Each tool also includes a tool arm 36A, 36B, 36C spaced between the base 32 and the head 34 of each tool. Each tool may be made from a metal such as steel, iron, chrome, aluminum, molybdenum, vanadium, sheet metal or other alloy or rigid material and the base, arm, and head of eat tool may have a generally continuous unitary orientation as they may all be made from the same mold or stamp. FIGS. 1-9 illustrate the bases 32A, 32B, 32C within a housing 40 while FIGS. 10-18 illustrate the folding tool assembly 20 without the housing 40 and illustrate the operation of the folding tool assembly 20.

The heads may have a multi-sized configuration having a fixed grip surface 38A, 38B, 38C designed to grip fasteners of a range of sizes. The top head 34A may be of a first size, the center head 34B may be of a second size and the bottom head 34C may be of a third size. The third size may be larger than the second size and the second size may be larger than the first size. The heads 34A, 34B, 34C may be a box head wrench style having a closed configuration. However, each or any one of the heads 34A, 34B, 34C may be an open head style. The heads 34A, 34B, 34C may be configured to include complementary shapes for standard sized fasteners. The heads 34A, 34B, 34C may be of any known wrench or rotary tool configuration and this disclosure is not limited as nearly all wrench style heads that exist in the prior art may be configured for utilization as the heads 34A, 34B, 34C of the folding tool assembly 20. For example, heads designed to grip two or more rotary fastener sizes, designed to grip a range of sizes, or are designed to be adjustable to multiple sizes may be utilized with the disclosed folding tool assembly 20. This disclosure also contemplates box end wrenches and open-end wrenches of various sizes, including the length and width of the tool arms and range of head sizes.

The folding tool assembly 20 may include a lockable hinge 100 that operates with a pushbutton 50. The pushbutton 50 may include an exposed portion that extends from the housing 40 to allow a user to selectively press the pushbutton 50. The pushbutton 50 may be biased between a locked position and an unlocked position. In one embodiment, the pushbutton 50 may be spring loaded such that it maintains a position at rest and the user applies pressure against a bias force to press the pushbutton 50 inwardly relative to the housing 40. Further, a biasing member 64 may be attached to the pushbutton body 52 to provide a bias force against the pushbutton 50—see FIG. 10.

The plurality of bases 32A, 32B, 32C may be positioned within the housing 40 and generally aligned along a common axis 60 such that each tool may be selectively rotated about the common axis 60 relative to the other tools. See FIGS. 10 and 16-19. The housing 40 may circumscribe the plurality of bases 32A, 32B, 32C.

As shown by FIGS. 10-18, a shaft 70 may be rotatably attached to the top tool 30A, the center tool 30B, and the bottom tool 30C along the common axis 60. The shaft 70 may be rotatably attached to the bases 32A, 32B, 32C of the tools. The pushbutton 50 may include an elongated body 52 that may extend within the housing 40. The body 52 may have a generally rounded orientation, as it may be generally cylindrical. However, other shapes or configurations are contemplated by this disclosure and the body 52 is not limited to having a generally cylindrical shape as it may also have rectangular, square, or other poly-sided cross sectional orientation. The body 52 may extend from the exterior of the housing 40 and extend passed bases 32A, 32B, 32C of the top, center and bottom tools 30A, 30B, 30C. The base 32A of the top tool 30A may have a circular orientation having a base surface such as an annular surface 33A that generally surrounds the base 32A. The annular surface 33A may extend between a first notch 56A and second notch 58A which may be positioned along the base 32A of the top tool 30A. Base 32B of the center tool 30B may include a circular orientation having an aperture 62 to movingly receive the body 52 of the pushbutton 50 therein. Base 32C of the bottom tool 30C may have a generally circular orientation having a base surface such as an annular surface 33C that generally surrounds the base 32C. The annular surface 33C may extend between a first notch 56C and second notch 58C which may be positioned along the base 32C of the bottom tool 30C.

The pushbutton body 52 may include a first cutout 54A and a second cutout 54C. In one embodiment, the folding tool assembly 20 may operate such that when in a rest position, the pushbutton is biased outwardly relative to the housing 40 and the cutouts 54A and 54C are positioned generally out of alignment from the annular surfaces 33A and 33C, respectively. In this position, an outer surface 55 of the pushbutton body 52 may be abutted within the first notch 56A of the base 32A of the top tool 30A and the outer surface of the pushbutton body 52 may be abutted within the first notch 56C of the base 32C of the bottom tool 30C. The base 32B of the center tool 30B may not be rotatable relative to the pushbutton body 52. In this orientation, the folding tool assembly 20 may be in a locked closed position as illustrated by FIGS. 1, 4-6, 10, 13-15.

When the pushbutton 50 is depressed against the bias force of the bias member 64, the body 52 may translate a first direction 72 through the aperture 62 of the base 32B of the center tool 30B. Further, the first cutout 54A may align with the annular surface 33A of the top tool 30A and the second cutout 54C may align with the annular surface 33C of the bottom tool 30C. This may allow a user to rotate at least one of the tools 30A, 30B, 30C about the common axis 60 relative to the others. This may also allow the user to rotate the tools from the closed position to the open position and vis versa.

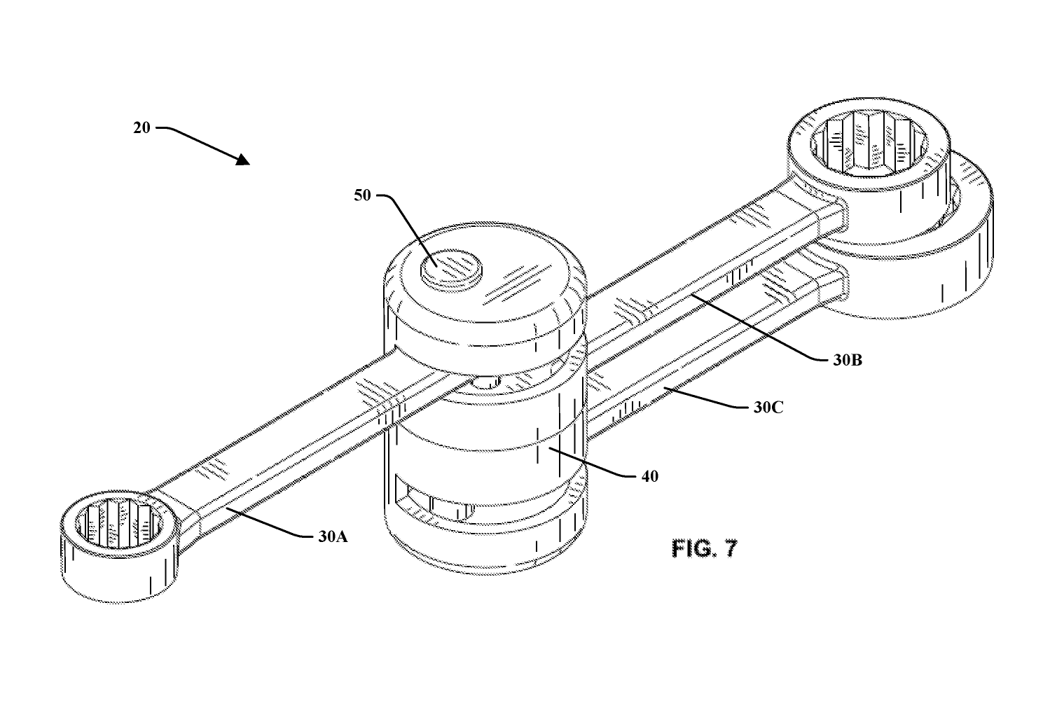

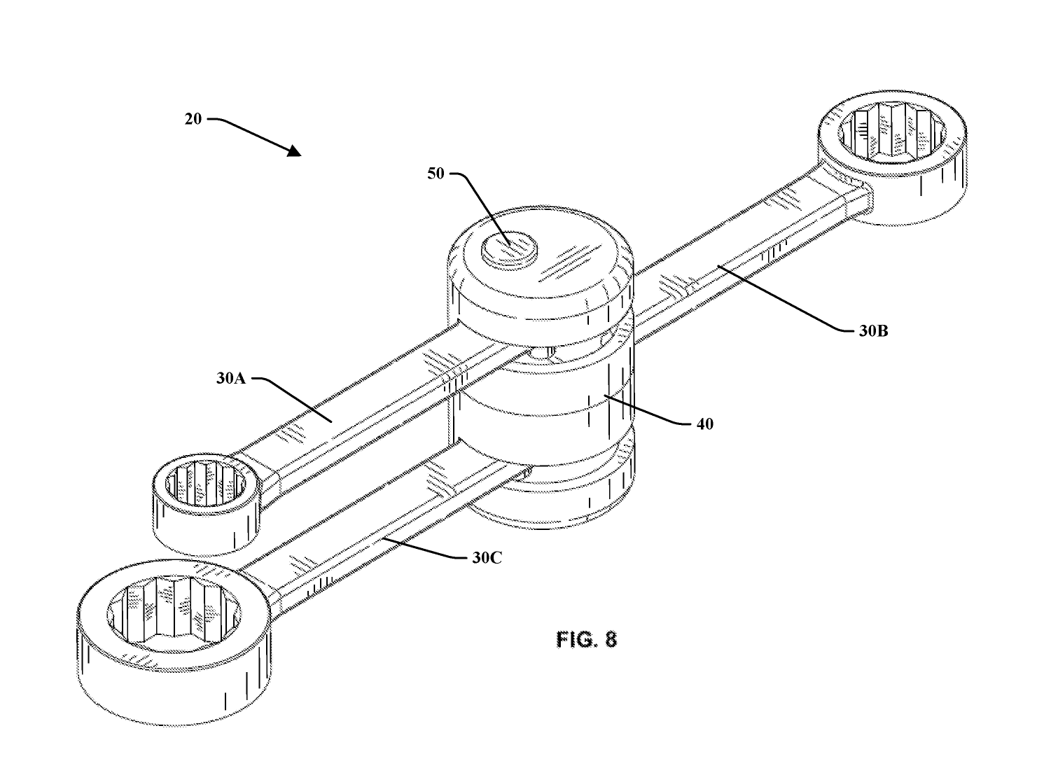

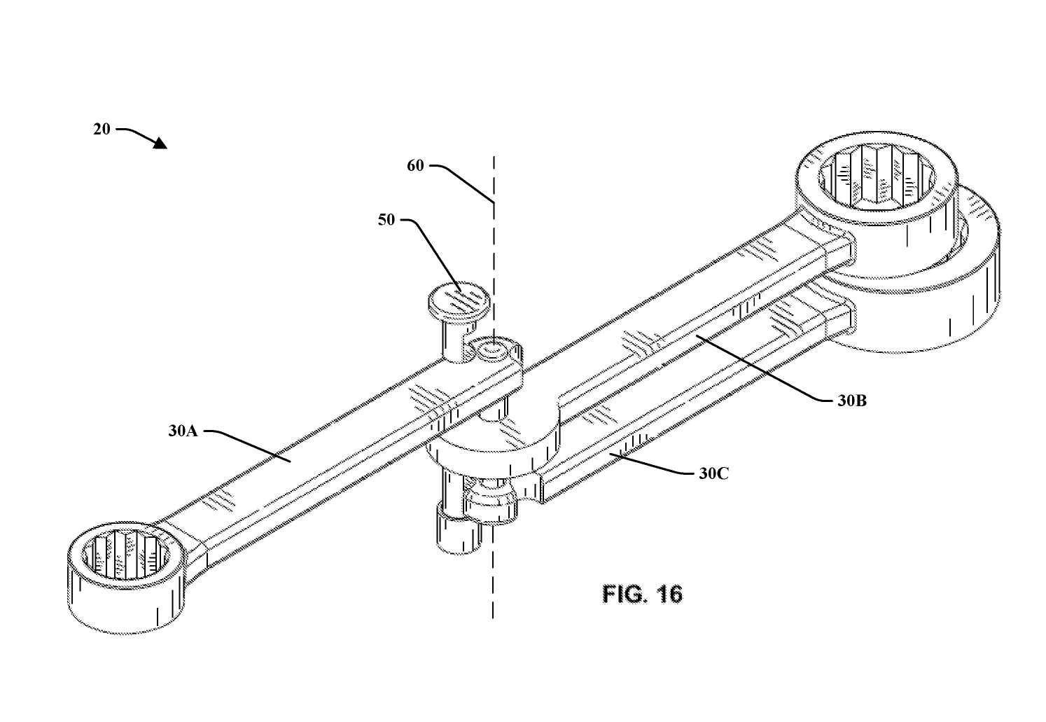

The top tool 30A may be selectively rotated about the common axis 60 when the annular surface 33A is received within the first cutout 54A. The arm 36A of the top tool 30A may be aligned to rotate within a slot 42A along a perimeter of the housing 40. See FIG. 1. When the second notch 58A aligns with the cutout 54A, the pushbutton body 52 may translate a second direction 74 through the aperture 62 of the base 32B of the center tool 32A such that the outer surface 55 of the pushbutton body 52 may be engaged or abutted within the second notch 58A of the base 32A of the top tool 30A. In this orientation, the top tool 30A of the folding tool assembly 20 may be in a locked open position as illustrated by FIGS. 7 and 16.

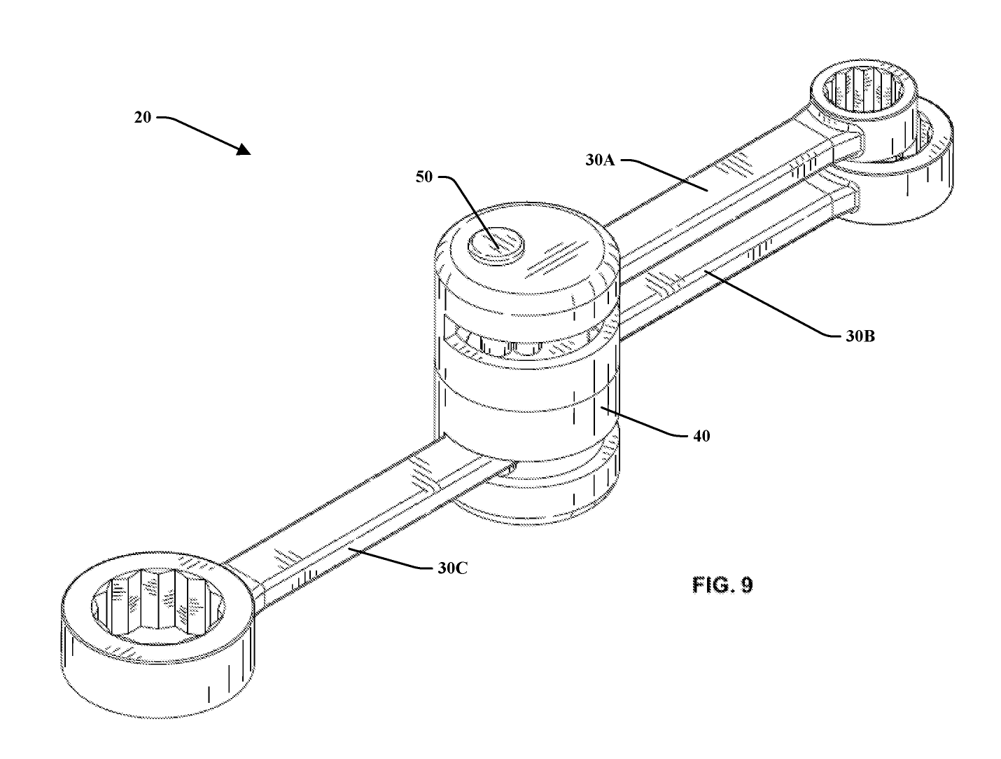

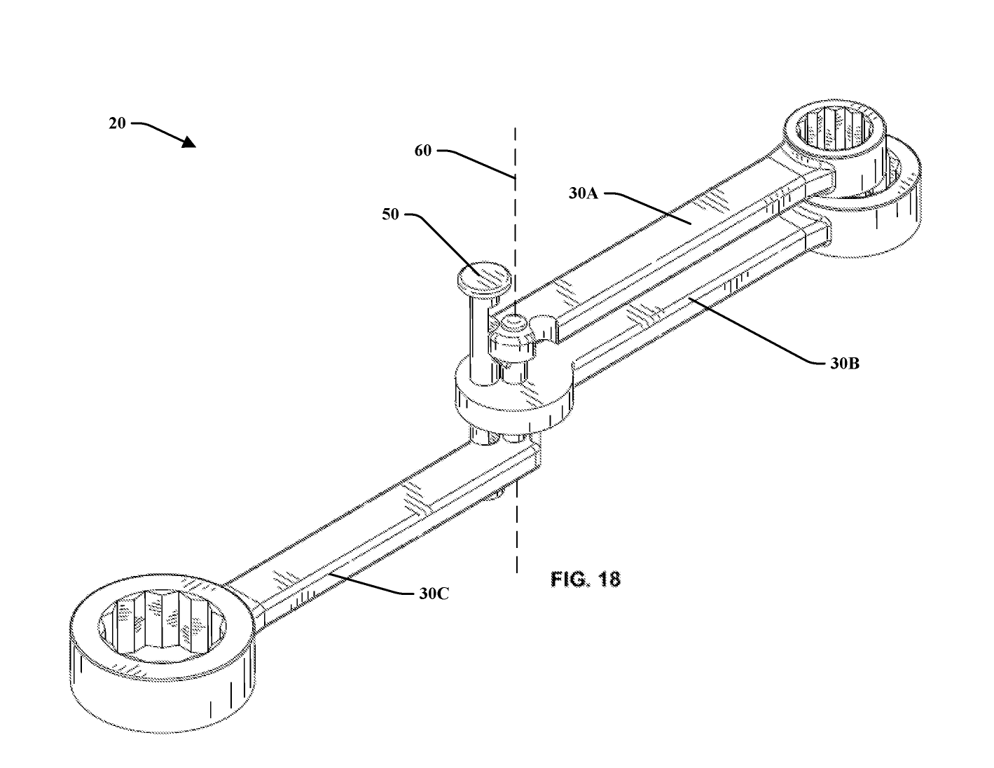

The bottom tool 30C may be selectively rotated about the common axis 60 when the annular surface 33C is received within the second cutout 54C. The arm 36C of the bottom tool 30C may be aligned to rotate within a slot 42C along a perimeter of the housing 40. See FIG. 1. When the second notch 58C aligns with the second cutout 54C, the pushbutton body 52 may translate in the second direction 74 such that the outer surface 55 of the pushbutton body 52 may be engaged or abutted within the second notch 58C of the base 32C of the bottom tool 30C. In this orientation, the bottom tool 30C of the folding tool assembly 20 may be configured in a locked open position as illustrated by FIGS. 9 and 18.

The center tool 30B may be selectively rotated about the common axis 60 when the annular surface 33A of the top tool 30A and the annular surface 33C and bottom tool 30C are received within the first cutout 54A and second cutout 54C, respectively. When the second notch 58A of the base 32A of the top tool 30A aligns with the first cutout 54A of the pushbutton body 52 and the second notch 58C of the base 32C of the bottom tool 30C aligns with the second cutout 54C of the pushbutton body 52, the pushbutton body 52 may translate in the second direction 74 such that the outer surface 55 of the pushbutton body 52 may be abutted within the first notch 58A of the base 32A of the top tool 30A and the second notch 58C of the base 32C of the bottom tool 30C. In this orientation, the center tool 30B of the folding tool assembly 20 may be configured in a locked open position as illustrated by FIGS. 9 and 18.

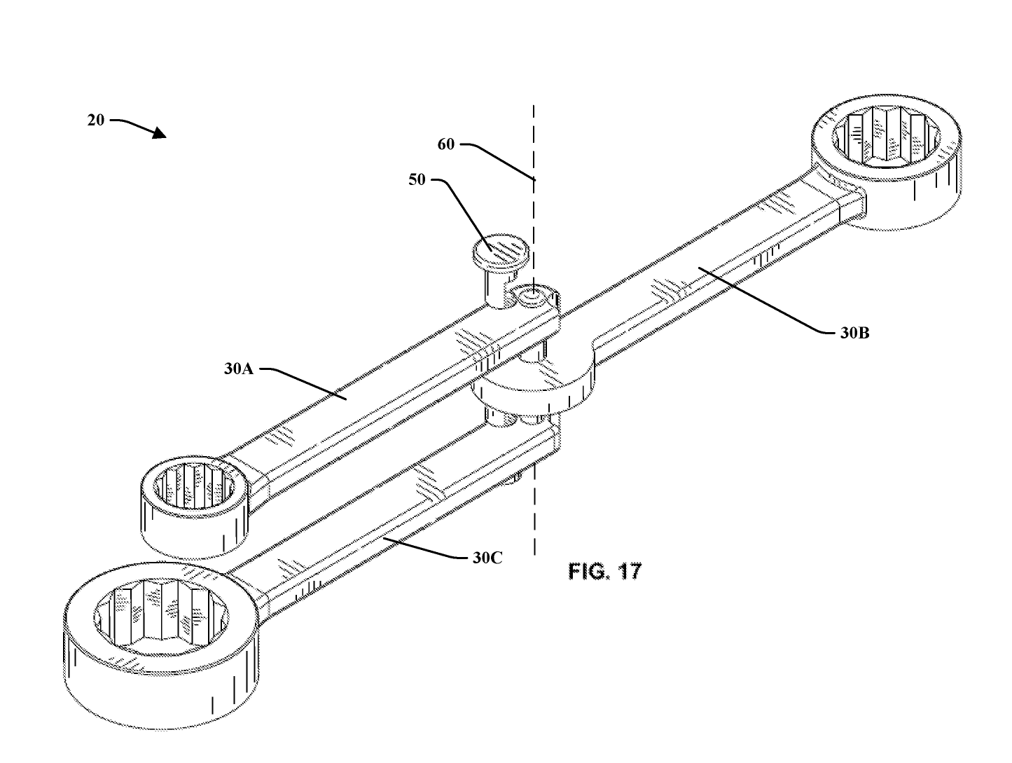

The top tool 30A may be rotated relative to the center tool 30B and bottom tool 30C and be positioned in an open position to apply the grip surface 38A of the head 34A to a fastener. See FIGS. 7 and 16. The center tool 30B may be rotated relative to the top tool 30A and bottom tool 30C and be positioned in an open position to apply the grip surface 38B of the head 34B to a fastener. See FIGS. 8 and 17. The bottom tool 30C may be rotated relative to the center tool 30B and top tool 30A and be positioned in an open position to apply the grip surface 38C of the head 34C to a fastener. See FIGS. 9 and 18.

In one embodiment, the pushbutton body 52 may be spaced from the shaft 70 and may be generally parallel to the common axis 60. The top and bottom tools 30A, 30C may be rotatably attached to the shaft 70. In the disclosed orientation, the center tool 30B may operate in a different manner than the top tool 30A and bottom tool 30C. However, the center tool 30B may be configured to operate in a common manner as the top tool 30A and bottom tool 30C. In particular, the center tool 30B may also include a base having a similar orientation as the top and bottom tools wherein the housing 40 may provide structural alignment of the pushbutton and the alignment of the tools.

FIG. 19 illustrates that the folding tool assembly 20 may be scalable to include a plurality of tools. In particular, the additional fourth, fifth and sixth tools may operate in a similar manner as described above regarding the first, second and third tools.

Although the embodiments of the present teachings have been illustrated in the accompanying drawings and described in the foregoing detailed description, it is to be understood that the present teachings are not to be limited to just the embodiments disclosed, but that the present teachings described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. A folding tool assembly comprising:
a top tool having a top head and a top base with a top base surface;
a center tool having a center head and a center base;
a bottom tool having a bottom head and a bottom base with a bottom base surface;
wherein the top, center, and bottom bases are rotatable along a common axis;
a lockable hinge including a pushbutton with an elongated body, wherein the elongated body is biased between locked and unlocked positions selectively aligning with the top and bottom base surfaces;
wherein the top, center, and bottom tools are placed in a closed locked position and an open locked position relative to the other tools.

2. The folding tool assembly of claim 1, wherein the pushbutton extends through an aperture within the center base of the center tool.

3. The folding tool assembly of claim 1, wherein the top tool and bottom tool are rotatably attached to a shaft aligned along the common axis.

4. The folding tool assembly of claim 1, wherein the pushbutton extends passed the top, center and bottom bases.

5. The folding tool assembly of claim 1, wherein the top base of the top tool includes a first notch and second notch that are selectively aligned with the first cutout of the pushbutton body.

6. The folding tool assembly of claim 1, wherein the bottom base of the bottom tool includes a first notch and a second notch that are selectively aligned with the second cutout of the pushbutton body.

7. The folding tool assembly of claim 1, wherein the top base, center base, and bottom base are positioned within a housing.

8. The folding tool assembly of claim 1, wherein the elongated body of the pushbutton is generally parallel to the common axis.

9. A folding tool assembly comprising:
a plurality of tools including a first tool having a first head and a first base with a first base surface, a second tool having a second head and a second base, and a third tool having a third head and a third base with a third base surface wherein the first, second and third bases are rotatable along a common axis;
a lockable hinge including a housing with a pushbutton, the pushbutton having an elongated body with cutouts, wherein the pushbutton is biased between a locked position and an unlocked position to selectively engage the cutouts with the first and third base surfaces; and
wherein each of the plurality of tools is selectively moveable between a closed locked position and an open locked position relative to another of the plurality of tools.

10. The folding tool assembly of claim 9, wherein the elongated body of the pushbutton extends through an aperture within the second base of the second tool.

11. The folding tool assembly of claim 9, wherein the first tool and third tool are rotatably attached to a shaft aligned along the common axis.

12. The folding tool assembly of claim 9, wherein the elongated body of the pushbutton extends passed the first base, the second base and the third base.

13. The folding tool assembly of claim 9, wherein the first base includes a first notch and a second notch that are selectively aligned with a first cutout of the elongated body wherein the first tool is in the open locked position when the second notch is engaged with the elongated body of the pushbutton and in the closed locked position when the first notch is engaged with the elongated body of the pushbutton.

14. The folding tool assembly of claim 9, wherein the third base includes a first notch and a second notch that are selectively aligned with the second cutout of the pushbutton body wherein the third tool is in the open locked position when the second notch is engaged with the elongated body of the pushbutton and in the closed locked position when the first notch is engaged with the elongated body of the pushbutton.

15. The folding tool assembly of claim 9, wherein the first base, the second base, and the third base are positioned within the housing.

16. The folding tool assembly of claim 9, wherein the elongated body of the pushbutton is generally parallel to the common axis.

17. The folding tool assembly of claim 9 wherein the first, second and third heads include a multi-sized configuration having a fixed grip surface to grip fasteners of a range of sizes.

18. The folding tool assembly of claim 17 wherein the first head has a first size, the second head has a second size and the third head has a third size, wherein the third size is larger than the second size and the second size is larger than the first size.

19. The folding tool assembly of claim 9 wherein the first, second and third heads are a box head wrench style having a closed configuration.

20. A folding tool assembly comprising:
a plurality of tools, each tool having an arm spaced between a head and a base wherein each of the bases are rotatable along a common axis; and
a lockable hinge including a housing and a pushbutton, wherein the housing generally circumscribes the bases of the plurality of tools and the pushbutton extends within the housing to be biased between locked and unlocked positions whereby the plurality of tools may be pivoted relative to each other in the unlocked position and the plurality of tools may be locked relative to each other in the locked position.
